(19) United States
(12) Patent Application Publication
(10) Pub. No.: US 2004/0122959 A1
(43) Pub. Date: Jun. 24, 2004

(54) Automatic wireless network login using embedded meta data

(76) Inventor: Victor B. Lortz, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/324,546

(22) Filed: Dec. 19, 2002

(51) Int. Cl. G06F 15/16

(52) U.S. Cl. 709/229; 713/201

(57) ABSTRACT

Briefly, in accordance with one embodiment of the invention, a user system may access a network such as the Internet via a local Internet service provider that the user may not have an agreement with by using wireless Internet service provider roaming. When a user sends a request to access the network, the local Internet service provider may intercept the request and return a login page to the user. In one embodiment, the returned login page may include extensible markup language meta information that provides information how the form should be filled out. A client on the user system may read the meta information and automatically complete the login form without user intervention. Upon completion of the login form, the user may be authenticated and allowed to access the network.

### DESCRIPTION OF THE DRAWING FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of a wireless Internet service provider roaming (WISPr) system in accordance with one embodiment of the present invention;

FIG. 2 is a flow diagram of a login redirect process in accordance with one embodiment of the present invention;

FIG. 3 is a flow diagram or a user authentication process in accordance with one embodiment of the present invention; and

FIG. 4 is a block diagram of a wireless communication system in accordance with one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It should be understood that embodiments of the present invention may be used in a variety of applications. Although the present invention is not limited in this respect, the circuits disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDAs) and the like.

Types of cellular radiotelephone communication systems intended to be within the scope of the present invention include, although not limited to, Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like.

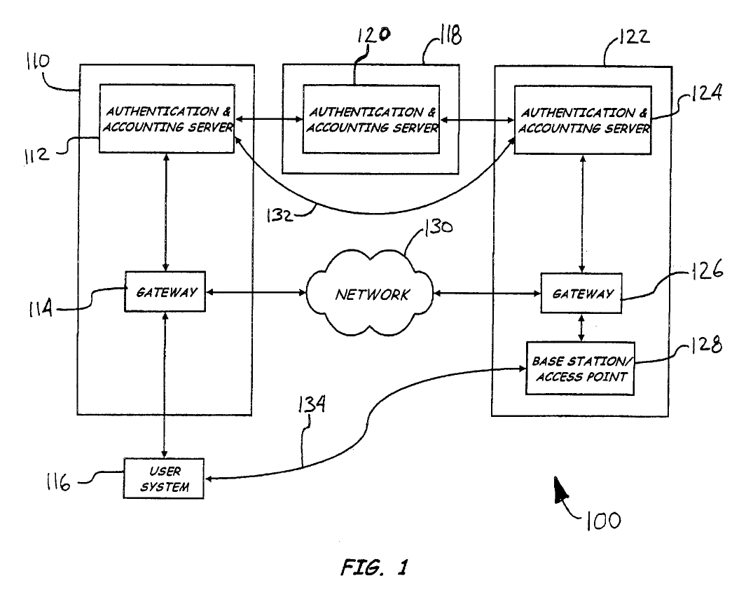

Referring now to FIG. 1, a block diagram of a wireless Internet service provider roaming (WISPr) system in accordance with one embodiment of the present invention will be discussed. A user system 116 in a wireless internet service provider (ISP) system 100 may have a service agreement with a home internet service provider (ISP) 110 to allow user system 116 to access a network 130, which in one embodiment may be the Internet, although the scope of the invention is not limited in this respect. User system 116 may connect to a gateway 114 of home ISP 110 using a login procedure established by home ISP 110. In one embodiment, the identity of user system 116 may be verified against a list of user accounts with a home ISP authentication & accounting server 112. Once the identity of user system 116 and the validity of a user account is verified by home ISP authentication & accounting server 112, user system 116 may be allowed to access network 130 via home ISP gateway 114. A client application running on user system 116 may handle the login and authentication procedure with home ISP authentication & accounting server 112, including handling any username and password login process, although the scope of the invention is not limited in this respect.

A user may desire to access network 130 via another ISP such as a local ISP 122. In one embodiment of the invention, local ISP 122 may be a wireless ISP (WISP) that may provide access to a user using an IEEE 802.11 compliant network. For example, user system 116 may connect to a base station or access point 128 of local ISP 122 using a wireless communication link 134, which in one embodiment may be an IEEE 802.11a or an IEEE 802.11b compliant wireless communication link. Such a local WISP 122 may be located at a public area such as an airport so that local WISP 122 may provide roaming users wireless access to network 130 via wireless communication link 134, although the scope if the invention is not limited in this respect.

As shown in FIG. 1, user system 116 may establish a wireless communication link 134 with base station or access point 128 and communicate with local ISP authentication & accounting server 124 via gateway 126. Authentication & accounting server 124 may communicate directly with home ISP authentication & accounting server 112 via direct connection 132 to verify the identity of user system 116 and to establish account information so that local ISP authentication & accounting server 124 may establish appropriate charges, costs, and billing information for allowing user system 116 to access network 130, although the scope of the invention is not limited in this respect. In an alternative embodiment, local ISP authentication & accounting server 124 may communicate with an intermediate authentication & accounting server 120 which may be owned and operated by a third party or entity 118 that may provide authentication and accounting services and auditing services to home ISP 110 and local ISP 122, although the scope of the invention is not limited in this respect.

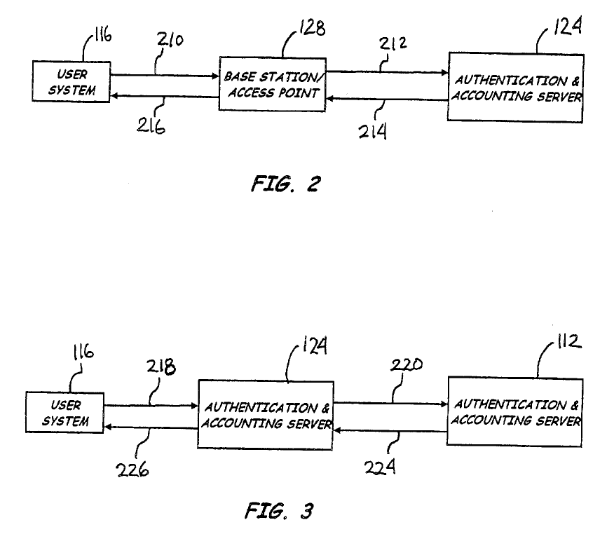

Referring now to FIG. 2, a flow diagram of a login redirect process in accordance with one embodiment of the present invention will be discussed. When user system 116 connects to a local ISP 122 as shown in FIG. 1, user system 116 may obtain an Internet protocol (IP) address and request a web page from network 130 via base station/access point 128 at arrow 210. Prior to providing access to network 130, base station/access 128 point may redirect the web page request to authentication & accounting server 124 of local ISP 122 at arrow 212, which may then send a login page back to base station/access point 128 at arrow 214. Base station/access point 128 may then provide the login page back to the client of user system 116 at arrow 216.

In accordance with one embodiment of the invention, the login page returned back to the client of user system 116 may include extensible markup language (XML) meta information that describes the login and cost information for accessing the local ISP 122. In one embodiment of the invention, the meta information may include what information is required by the user to complete the login page, for example, a username and password, so that the client running on user system 116 may automatically fill out the login page without using user intervention. After the client on user system 116 completes the login page and provides the required information, without requiring action by the user, the client may then return the complete login information to local ISP 122 for authentication and accounting as shown in and described with respect to FIG. 3, although the scope of the invention is not limited in this respect.

Referring now to FIG. 3, a flow diagram or a user authentication process in accordance with one embodiment of the present invention will be discussed. Subsequent to user system 116 receiving a login page from local ISP 122 that includes XML meta information regarding the login procedure and pricing information, the client on user system 116 may process the XML meta information, compose a hyper text markup language (HTML) login form based on the XML meta information, and then post the login form to local ISP authentication & accounting server 124 at arrow 218. Local ISP authentication & accounting server 124 may then couple with home ISP authentication & accounting server 112 at arrow 220 to authenticate user system 116 with home ISP 110. Once home ISP 110 authenticates user system 116, home ISP authentication & accounting server 112 may provide XML based cost information to local ISP authentication & accounting server 124 at arrow 224. Local ISP authentication & accounting server 124 may then provide the pricing information to the client of user system 116. If the costs are acceptable, the smart client of user system may be allowed to access network 130. Otherwise, if the cost information is not acceptable, then the client of user system 116 may automatically log out without incurring charges, although the scope of the invention is not limited in this respect.

In one embodiment of the invention, the method for embedding the meta information on a hyper text markup language (HTML) web page may be to utilize extensible markup language (XML) to encode the login and cost information. Local ISP 122 may then include this XML on its websites via local ISP authentication & accounting server 124, making the information available to the client of user system 116. For example, the redirection web page may be structured as follows:

<HTML>

<HEAD>

Welcome to ACME WISP . . .

<XML ID=“WISPLoginData” SRC=“https://www.ACMEWISP.com/logininfo.xml”></XML>

more info . . .

</HEAD>

Rest of the page here . . .

</HTML>

To enable the client of user system 116 to reliably identify the link for the meta-information, the ID attribute name “WISPLoginData” may be standardized. In another embodiment, the format of the meta-information file may be specified. For example:

<?xml version=“ 1.0” encoding=“UTF-8”?>

<WISPLoginData>

<Login>

<URL>https://someURI/logon.asp</URL>

<Form method=“Post”>

<UserName name=“username”/>

<Password name=“password”/>

<Realm name=“realm”/>

<HiddenField name=“someField” value=“randomValue”/>

</Form>

</Login>

<Logout>

<URL>https://someURI/logoff.asp</URL>

<Form method=“Post”>

<SessionID name=“username”/>

</Form>

</Logout>

<WhiteList>

<URL>http://someURI</URL>

<LRL>http://someOtherURI</URL>

</WhiteList>

</WISPLoginData>

Given information such as that shown above, the client of user system 116 may be able to automatically post the appropriate information to the login web site at local ISP 122. A similar technique may also be used by home ISP 110 which may maintain a billing relationship with the user of user system 116 to communicate information about charges to a the client of user system 116:

<HTML>

<HEAD>

Welcome to Your Home WISP . . .

<XML ID=“WISPChargeData” SRC=“https://www.HomeWISP.com/charginginfo.xml”></XML>

more info . . .

</HEAD>

Rest of the page here . . .

</HTML>

Where charginginfo.xml maybe the following or the like:

<?xml version=“1.0” encoding=“UTF-8”?>

<WISPChargeData>

<Charges>

<PerMinute>

<USD>0.30</USD>

</PerMinute>

<PerLogin>

<USD>0.50</USD>

</PerLogin>

</Charges>

</WISPChargeData>

It should be noted that the scope of the present invention is not limited to this particular implementation.

Thus, when user system 116 makes a request to access network via local ISP 122, the client running on user system 116 may automatically provide the requested login information to local ISP authentication & accounting server 124 without requiring involvement of the user, for example typing in a username and password, clicking an enter or an okay button, etc., since the client may automatically provide this information to local ISP authentication & accounting server 124 based on the XML meta information provided by local ISP authentication & accounting server 124. Furthermore, when user system 116 receives pricing information for roaming access per an agreement between home ISP 110 and the user of user system 116, the client of user system 116 may be programmed to automatically accept or reject the charges that may incur during access without involvement of the user. As a result, user system 116 may automatically gain access to network 130 via local ISP 122 without requiring the user manually enter data into the login form of local ISP 110, and the user may additionally avoid undesired charges via inadvertent access to local ISP 122, although the scope of the invention is not limited in this respect. For example, user system 116 may utilize an instant messaging program that is left open for continuous periods of time so that messages from a remote user may be received via network 130 without requiring the user of user system 116 to manually login to check for such a message. In addition, the wireless system 100 in accordance with an embodiment of the invention may allow a user to roam between multiple local ISPs without requiring the user to manually login when new ISPs are encountered, although the scope of the invention is not limited in this respect.

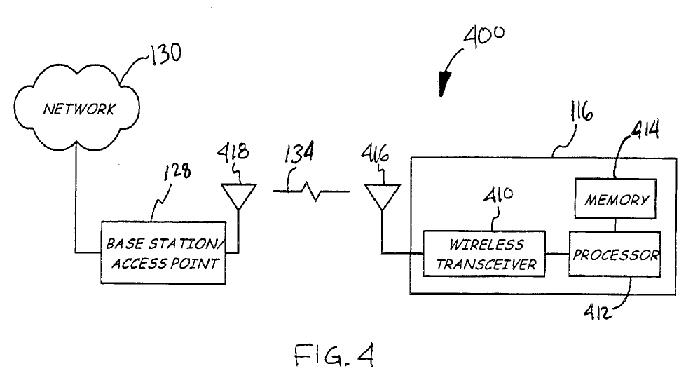

Referring now to FIG. 4, a wireless communication system in accordance with one embodiment of the present invention will be discussed. In the communications system 100 shown in FIG. 4, a user system 116 may include a wireless transceiver 410 to couple to an antenna 416 and to a processor 412. Processor 412 in one embodiment may comprise a single processor, or alternatively may comprise a baseband processor and an applications processor, although the scope of the invention is not limited in this respect. Processor 412 may couple to a memory 414 which may include volatile memory such as DRAM, non-volatile memory such as flash memory, or alternatively may include other types of storage such as a hard disk drive, although the scope of the invention is not limited in this respect. Some portion or all of memory 414 may be included on the same integrated circuit as processor 412, or alternatively some portion or all of memory 414 may be disposed on an integrated circuit or other medium, for example a hard disk drive, that is external to the integrated circuit of processor 412, although the scope of the invention is not limited in this respect.

User system 116 may communicate with base station/access point 128 via wireless communication link 134, where base station/access point 128 may include at least one antenna 418. Base station/access point 128 may couple with network 130 so that user system 116 may communicate with network 130, including devices coupled to network 130, by communicating with base station/access point 128 via wireless communication link 134. Network 130 may include a public network such as a telephone network or the Internet, or alternatively network 130 may include a private network such as an intranet, or a combination of a public and a private network, although the scope of the invention is not limited in this respect. Communication between user system 116 and base station/access point 128 may be implemented via a wireless local area network (WLAN), for example a network compliant with a an Institute of Electrical and Electronics Engineers (IEEE) standard such as IEEE 802.11a, IEEE 802.11b, and so on, although the scope of the invention is not limited in this respect. In another embodiment, communication between user system 128 and base station/access point 128 may be implemented via a cellular communication network compliant with a 3GPP standard, although the scope of the invention is not limited in this respect.

Although the invention has been described with a certain degree of particularity, it should be recognized that elements thereof may be altered by persons skilled in the art without departing from the spirit and scope of the invention. It is believed that the communications subsystem for wireless devices or the like of the present invention and many of its attendant advantages will be understood by the forgoing description, and it will be apparent that various changes may be made in the form, construction and arrangement of the components thereof without departing from the scope and spirit of the invention or without sacrificing all of its material advantages, the form herein before described being merely an explanatory embodiment thereof, and further without providing substantial change thereto. It is the intention of the claims to encompass and include such changes.

What is claimed is:

1. A method, comprising:
receiving a request from a user to access a network; and
prior to allowing the user to access the network, sending a login page to the user, the login page including information describing how the login page is to be completed.

2. A method as claimed in claim 1, wherein said sending includes sending extensible markup language information describing to the user how the login page is to be completed.

3. A method as claimed in claim 1, further comprising authenticating the user prior to allowing the user to access the network.

4. A method as claimed in claim 1, further comprising authenticating the user with a home Internet service provider of the user.

5. A method as claimed in claim 1, further comprising authenticating the user with a home Internet service provider of the user, the home Internet service provider providing pricing information back to the user.

6. A method as claimed in claim 1, further comprising authenticating the user with a home Internet service provider of the user, the home Internet service provider providing pricing information back to the user, and in the event the pricing information is satisfactory, allowing the user to access the network.

7. A method as claimed in claim 1, further comprising authenticating the user with a home Internet service provider of the user, and in the event the user is authenticated, allowing the user to access the network.

8. A method as claimed in claim 1, further comprising authenticating the user with a home Internet service provider of the user, the home Internet service provider providing pricing information back to the user, and in the event the user is authenticated and the pricing information is satisfactory, allowing the user to access the network.

9. An article comprising a storage medium having stored thereon instructions that, when executed by a computing platform, result in a user automatically accessing a network when roaming, by:
receiving a request from a user to access a network; and
prior to allowing the user to access the network, sending a login page to the user, the login page including information describing how the login page is be completed.

10. An article as claimed in claim 9, wherein the instructions, when executed, further result in sending extensible markup language information describing to the user how the login page is to be completed.

11. An article as claimed in claim 9, wherein the instructions, when executed, further result in authenticating the user prior to allowing the user to access the network.

12. An article as claimed in claim 9, wherein the instructions, when executed, further result in authenticating the user with a home Internet service provider of the user.

13. An article as claimed in claim 9, wherein the instructions, when executed, further result in authenticating the user with a home Internet service provider of the user, the home Internet service provider providing pricing information back to the user.

14. An article as claimed in claim 9, wherein the instructions, when executed, further result in authenticating the user with a home Internet service provider of the user, the home Internet service provider providing pricing information back to the user, and in the event the pricing information is satisfactory, allowing the user to access the network.

15. An article as claimed in claim 9, wherein the instructions, when executed, further result in authenticating the user with a home Internet service provider of the user, and in the event the user is authenticated, allowing the user to access the network.

16. An article as claimed in claim 9, wherein the instructions, when executed, further result in authenticating the user with a home Internet service provider of the user, the home Internet service provider providing pricing information back to the user, and in the event the user is authenticated and the pricing information is satisfactory, allowing the user to access the network.

17. A method, comprising:
requesting to access a network;
receiving a login page in response to the request, the login page including information to allow the login page to be completed and returned without user intervention;
completing the login page based on the information with user intervention; and
returning the completed login page without user intervention.

18. A method as claimed in claim 17, further comprising receiving pricing information for network access, determining whether the pricing information is acceptable, and in the event the pricing information is acceptable, accepting the pricing information without user intervention to allow access to the network.

19. A method as claimed in claim 17, wherein said receiving includes receiving extensible markup language information related to completing the login page.

20. An article comprising a storage medium having stored thereon instruction that, when executed by a computing platform, result in automatically logging on to a network, by:
requesting to access a network;
receiving a login page in response to the request, the login page including information to allow the login page to be completed and returned without user intervention;
completing the login page based on the information with user intervention; and
returning the completed login page without user intervention.

21. An article as claimed in claim 20, wherein the instructions, when executed, further result in receiving pricing information for network access, determining whether the pricing information is acceptable, and in the event the pricing information is acceptable, accepting the pricing information without user intervention to allow access to the network.

22. An article as claimed in claim 20, wherein the instructions, when executed, further result in receiving extensible markup language information related to completing the login page.

23. A method, comprising:
requesting to access a network;
receiving a login page in response to the request, the login page including information to allow the login page to be completed and returned by a client running on a user system;
completing the login page based on the information using the client; and
returning the completed login page using the client.

24. A method as claimed in claim 23, further comprising receiving pricing information for network access, determining whether the pricing information is acceptable, and in the event the pricing information is acceptable, accepting the pricing information using the client to allow access to the network.

25. A method as claimed in claim 23, wherein said receiving includes receiving extensible markup language information related to completing the login page.

26. An article comprising a storage medium having stored thereon instruction that, when executed by a computing platform, result in automatically logging on to a network, by:
requesting to access a network;
receiving a login page in response to the request, the login page including information to allow the login page to be completed and returned by a client running on the user system;
completing the login page based on the information using the client; and
returning the completed login page.

27. An article as claimed in claim 26, wherein the instructions, when executed, further result in receiving pricing information for network access, determining whether the pricing information is acceptable, and in the event the pricing information is acceptable, accepting the pricing information using the client to allow access to the network.

28. An article as claimed in claim 26, wherein the instructions, when executed, further result in receiving extensible markup language information related to completing the login page.

29. An article comprising a storage medium having stored thereon instruction that, when executed by a computing platform, result in automatically logging on to a network, by:
requesting to access a network;
receiving a login page in response to the request, the login page including information to allow the login page to be completed and returned without user intervention;
completing the login page based on the information with user intervention; and
returning the completed login page without user intervention.

30. An article as claimed in claim 29, wherein the instructions, when executed, further result in receiving pricing information for network access, determining whether the pricing information is acceptable, and in the event the pricing information is acceptable, accepting the pricing information without user intervention to allow access to the network.

31. An article as claimed in claim 29, wherein the instructions, when executed, further result in receiving extensible markup language information related to completing the login page.
